(19) United States
(12) Patent Application Publication
(10) Pub. No.: US 2025/0093043 A1
(43) Pub. Date: Mar. 20, 2025

(54) CLOSED LOOP GRIDDLE OPERATION FOR A COOKTOP APPLIANCE

(71) Applicant: Haier US Appliance Solutions, Inc., Wilmington, DE (US)

(72) Inventor: Paul Bryan Cadima, Crestwood, KY (US)

(21) Appl. No.: 18/471,006

(22) Filed: Sep. 20, 2023

(51) Int. Cl. F24C 3/12; A47J 37/06; F24C 7/08; G05D 23/19

(52) U.S. Cl. CPC F24C 3/126; A47J 37/0682; G05D 23/1917; F24C 7/087

(57) ABSTRACT

A method of operating a cooktop includes receiving a request to perform a griddle cooking operation on a griddle, receiving a food type or a food quantity of food being cooked during the griddle cooking operation, providing user instruction on a graphical user interface based at least in part on the food type or the food quantity, the user instruction including at least one of a food positioning recommendation, a food flip interval, an optimum volume or mass of food, an elapsed cooking time, or a remaining cooking time, and operating a one or more heating elements to perform the griddle cooking operation.

### FIELD OF THE INVENTION

The present subject matter relates generally to gas cooktops, and more particularly, to methods for performing closed loop cooking operations using a griddle on a gas cooktop.

### BACKGROUND OF THE INVENTION

Conventional gas cooktop appliances have one or more gas burners, e.g., positioned at a cooktop surface for use in heating or cooking an object, such as a cooking utensil and its contents. These gas burners typically combust a mixture of gaseous fuel and air to generate heat for cooking. These gas cooktops may include a grate or other support structure for receiving various cooking utensils, such as a griddle. For example, griddles may be positioned on the grate of the gas cooktop and may extend across multiple gas burners to provide a large, flat cooking surface.

Household cooking appliances equipped with closed loop-controlled griddles are known. However, while controlling the temperature of the cooking surface of a griddle is known, existing cooking appliances provide little to no guidance regarding how to use the griddle most effectively for a given cooking task. Indeed, consumers may position food in an incorrect way, may rotate or turn food at the wrong time, may cook a wrong size or volume of food, or make other mistakes when using the griddle. Solutions to improve the griddle experience for users having an automatically controlled griddle and a means to display information is currently lacking.

Accordingly, it would be useful to have an appliance where usage information and instructions could be provided to a user specific to an included griddle when a griddle mode was active. A method of prompting for food type after a griddle mode has been activated, automatically controlling the griddle heat in accordance with the task and providing visual instructions for optimum positioning of foods for best results could be helpful to optimize performance and user experience.

### BRIEF DESCRIPTION OF THE INVENTION

Aspects and advantages of the invention will be set forth in part in the following description, or may be apparent from the description, or may be learned through practice of the invention.

In one exemplary embodiment, a method of operating a cooktop is provided. The cooktop includes one or more heating elements, a griddle removably positioned over the one or more heating elements, and a graphical user interface. The method includes receiving a request to perform a griddle cooking operation, receiving a food type of food being cooked during the griddle cooking operation, providing user instruction on the graphical user interface based at least in part on the food type, the user instruction comprising a food positioning recommendation, and operating the one or more heating elements to perform the griddle cooking operation.

In another exemplary embodiment, a cooktop defining a vertical direction, a lateral direction, and a transverse direction is provided. The cooktop includes one or more heating elements, a griddle removably positioned over the one or more heating elements, a temperature sensing assembly operably coupled to the griddle for monitoring a cooking temperature of the griddle, a graphical user interface, and a controller in operative communication with the one or more heating elements, the temperature sensing assembly, and the graphical user interface. The controller is configured to receive a request to perform a griddle cooking operation, receive a food type of food being cooked during the griddle cooking operation, provide user instruction on the graphical user interface based at least in part on the food type, the user instruction comprising a food positioning recommendation, and operate the one or more heating elements to perform the griddle cooking operation.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gas cooktop including a griddle assembly according to an example embodiment of the present subject matter.

FIG. 2 provides a schematic view of a control knob sequence to facilitate control of the example griddle assembly of FIG. 1 according to example embodiments of the present subject matter.

FIG. 3 is a method of operating a cooktop appliance according to an exemplary embodiment of the present subject matter.

FIG. 4 illustrates an interactive display providing user instructions according to an example embodiment of the present subject matter.

FIG. 5 illustrates the interactive display providing user instructions according to an example embodiment of the present subject matter.

FIG. 6 illustrates the interactive display providing user instructions according to an example embodiment of the present subject matter.

FIG. 7 is a flow diagram or decision tree illustrating the operation of a cooktop appliance according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

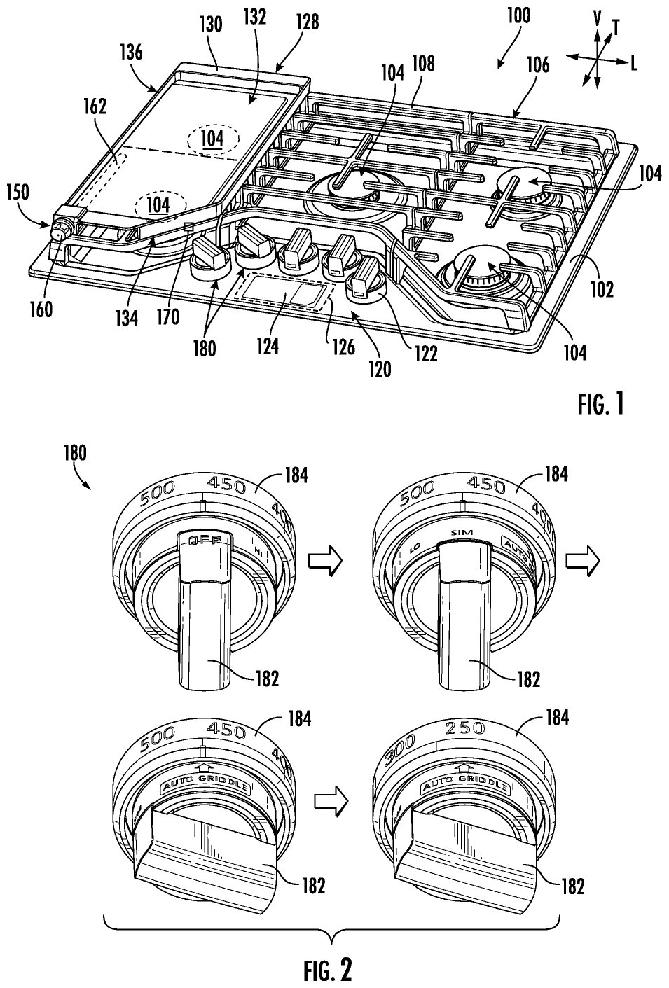

FIG. 1 illustrates an exemplary embodiment of a cooktop appliance, e.g., a gas cooktop 100, of the present disclosure. Gas cooktop 100 may be fitted integrally with a surface of a kitchen counter, may be configured as a slide-in cooktop unit, may be a part of a free-standing range cooking appliance, etc. Gas cooktop 100 may generally define a vertical direction V, a lateral direction L, and a transverse direction T, each of which is mutually perpendicular, such that an orthogonal coordinate system is generally defined. References to the horizontal direction or plane may refer generally to the plane defined by the lateral direction L and the transverse direction T.

Gas cooktop 100 includes a top panel 102 that includes one or more heating sources, such as heating elements 104 for use in, e.g., heating or cooking. Top panel 102, as used herein, refers to any upper surface of gas cooktop 100 over which utensils may be heated and therefore food cooked. In general, top panel 102 may be constructed of any suitably rigid and heat resistant material capable of supporting heating elements 104, cooking utensils, and/or other components of gas cooktop 100. By way of example, top panel 102 may be constructed of enameled steel, stainless steel, glass, ceramics, and combinations thereof.

According to the illustrated embodiment, the heating elements 104 of gas cooktop 100 are gas burners. However, although referred to as “gas cooktop” herein, it should be appreciated that aspects of the present subject matter may be applicable to other cooktop appliances, e.g., such as electrical resistance cooktops, inductive cooktops, etc. In addition, gas cooktop 100 may include one or more grates 106 configured to support a cooking utensil, such as a pot, pan, etc. In general, grates 106 include a plurality of elongated members 108, e.g., formed of cast metal, such as cast iron. The cooking utensil may be placed on the elongated members 108 of each grate 106 such that the cooking utensil rests on an upper surface of elongated members 108 during the cooking process. Heating elements 104 are positioned underneath the various grates 106 such that heating elements 104 provide thermal energy to cooking utensils above top panel 102 by combustion of fuel below the cooking utensils.

In some embodiments, the heating elements 104 of gas cooktop 100 may include a plurality of gas burners that are positioned on and/or within top panel 102 and have various sizes, as shown in FIG. 1, so as to provide for the receipt of cooking utensils (i.e., pots, pans, etc.) of various sizes and configurations and to provide different heat inputs for such cooking utensils. The top panel 102 may also include a recessed portion, e.g., which extends downward along the vertical direction V. The heating elements 104 may be positioned within the recessed portion. The recessed portion may collect spilled material, e.g., foodstuffs, during operation of the gas cooktop 100.

In the illustrated example embodiments, each heating element 104 includes a generally circular shape from which a flame may be emitted. Each heating element 104 may also include a plurality of fuel ports defined circumferentially in fluid communication with an internal passage of each respective heating element 104. In some embodiments, one or more of the heating elements 104 may be a multi-ring burner. For example, heating elements 104 may include a first plurality of fuel ports defining a first ring and a second plurality of fuel ports defining a second ring. In such embodiments, a first fuel chamber in fluid communication with the first plurality of fuel ports may be separated from a second fuel chamber in fluid communication with the second plurality of fuel ports by a wall within the heating element 104, and fuel may be selectively supplied to one or both of the fuel chambers within heating element 104. In some embodiments of a cooktop appliance, multiple burners of differing types may be provided in combination, e.g., one or more single-ring burners as well as one or more multi-ring burners. Moreover, other suitable burner configurations are also possible.

According to the illustrated example embodiment, a user interface panel or control panel 120 is located within convenient reach of a user of gas cooktop 100. For this example embodiment, control panel 120 includes control knobs 122 that are each associated with one of heating elements 104. Control knobs 122 allow the user to activate each heating element 104 and regulate the amount of heat input each heating element 104 provides to a cooking utensil located thereon. Although gas cooktop 100 is illustrated as including control knobs 122 for controlling heating elements 104, it will be understood that control knobs 122 and the configuration of gas cooktop 100 shown in FIG. 1 is provided by way of example only. More specifically, control panel 120 may include various input components, such as one or more of a variety of touch-type controls, electrical, mechanical, or electro-mechanical input devices including rotary dials, push buttons, and touch pads.

According to the illustrated embodiment, control knobs 122 are located within control panel 120 of gas cooktop 100. However, it should be appreciated that this location is used only for the purpose of explanation, and that other locations and configurations of control panel 120 and control knobs 122 are possible and within the scope of the present subject matter. Indeed, according to alternative embodiments, control knobs 122 may instead be located directly on top panel 102 or elsewhere on gas cooktop 100, e.g., on a backsplash, front bezel, or any other suitable surface of gas cooktop 100. Control panel 120 may also be provided with one or more graphical display devices, such as a digital or analog display device designed to provide operational feedback to a user. For example, as best shown in FIGS. 1 and 2, gas cooktop 100 may further include an interactive display 124, e.g., such a touch screen display for facilitating user interaction, providing user notifications, etc. For example, interactive display 124 may be a graphical user interface, a liquid crystal display (“LCD”), or any other suitable screen for providing and/or receiving information and commands from a user of gas cooktop 100.

Referring again to FIG. 1, operation of the gas cooktop 100 may be regulated by a controller 126 that is operably coupled to (i.e., in operative communication with) the user inputs (e.g., control knobs 122) and/or heating elements 104. In this regard, control panel 120, control knobs 122, interactive display 124, and other suitable inputs/outputs may be in communication with controller 126 such that controller 126 may regulate operation of gas cooktop 100. For example, signals generated by controller 126 may operate gas cooktop 100, including any or all system components, subsystems, or interconnected devices, in response to the position of control knobs 122 and other control commands. Control panel 120 and other components of gas cooktop 100 may be in communication with controller 126 via, for example, one or more signal lines or shared communication busses. In this manner, Input/Output (“I/O”) signals may be routed between controller 126 and various operational components of gas cooktop 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 126 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 126 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 126 may be operable to execute programming instructions or micro-control code associated with an operating cycle of gas cooktop 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 126 as disclosed herein is capable of and may be operable to perform any methods, method steps, or portions of methods as disclosed herein. For example, in some embodiments, methods disclosed herein may be embodied in programming instructions stored in the memory and executed by controller 126.

The memory devices may also store data that can be retrieved, manipulated, created, or stored by the one or more processors or portions of controller 126. The data can include, for instance, data to facilitate performance of methods described herein. The data can be stored locally (e.g., on controller 126) in one or more databases and/or may be split up so that the data is stored in multiple locations. In addition, or alternatively, the one or more database(s) can be connected to controller 126 through any suitable network(s), such as through a high bandwidth local area network (LAN) or wide area network (WAN). In this regard, for example, controller 126 may further include a communication module or interface that may be used to communicate with one or more other component(s) of gas cooktop 100, controller 126, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

As shown in FIG. 1. gas cooktop 100 may further include a griddle assembly 128 that may be installed on gas cooktop 100 as a cooking utensil. In general, griddle assembly 128 may include a griddle 130 that it selectively disposed over (e.g., directly above) one or more spaced-apart heating elements 104. For example, according to the illustrated embodiment, griddle 130 is positioned over a pair of burners, e.g., over the two leftmost heating elements 104 to define a single, flat cooking surface selectively heated by heating elements 104.

Specifically, during use, a top surface 132 of griddle 130 (i.e., a cooking surface) faces away from top panel 102 to receive a cooking item (e.g., food) thereon. By contrast, a bottom surface 134 may be opposite from top surface 132 and faces top panel 102 during use. Thus, the bottom surface 134 may face top panel 102 to receive a thermal output (e.g., flame or heated air) from the corresponding heating elements 104. Although the present disclosure discusses the use of griddle 130 as the cooking utensil for use with gas cooktop 100, it should be appreciated that aspects of the present subject matter may apply to the use of other cooking utensils as well, e.g., such as a skillet, a pot, a pan, etc.

The bottom surface 134 of the griddle 130 may be supported by grate 106 when positioned on gas cooktop 100. For example, bottom surface 134 of the griddle 130 may be in contact with one or more elongated members 108 of grate 106, such as with a peripheral support surface and an intermediate support surface thereof. In addition, it should be appreciated that grate 106 and/or griddle 130 may define complementary features to facilitate proper positioning and alignment of griddle 130 on gas cooktop 100. In this regard, grate 106 may define engagement features (e.g., such as elongated members 108) and griddle 130 may define complementary features (e.g., such as a geometry of supporting feet). For example, as illustrated in the figures, griddle 130 may define an outer side 136, e.g., an outer perimeter of griddle 130 within a horizontal plane (e.g., defined by the lateral direction L and the transverse direction T). Outer side 136 may have a geometry or engagement features that are designed to engage griddle 130, such that the engagement features and the complementary features interact to secure the position of griddle 130. Grate 106 and griddle 130 may further define one or more protrusions and complementary detents, complementary ribs and grooves, etc.

Notably, it may be desirable to use griddle 130 to cook more than one type of food. In addition, it may be desirable to cook each food at a separate griddle temperature. Accordingly, gas cooktop 100 and griddle assembly 128 may be a multi-zone cooktop and griddle assembly. Specifically, according to an example embodiment, griddle 130 defines a first heating zone and a second heating zone. In general, the first heating zone and the second heating zone are different regions defined on top surface 132 of griddle 130 where different food items may be cooked and different temperatures may be maintained. It should be appreciated that according to alternative embodiments, aspects of the present subject matter may include any other suitable number, size, geometry, and configuration of heating zones.

In addition, according to an example embodiment, a first gas burner may generally be positioned below the first heating zone and a second gas burner may generally be positioned below the second heating zone, e.g., to heat each zone respectively. However, it should be appreciated that more than two heating elements 104 may be used to collectively heat one or both of the first heating zone and the second heating zone. The specific heating zone configuration described herein is only intended to facilitate discussion of aspects of the present subject matter and is not intended to be limiting in any manner.

In some embodiments, gas cooktop 100 may be configured for closed-loop cooking. For example, controller 126 may be operable to receive a set temperature (such as from a user input of the gas cooktop 100 or wirelessly from a remote device such as a smartphone) and compare the set temperature to temperature measurements from one or more temperature sensors, such as a temperature sensor associated with a cooking utensil (such as griddle 130). Controller 126 may be further programmed to automatically adjust each burner, such as a fuel flow rate to each burner, based on the comparison of the corresponding temperature measurement to the set temperature.

Accordingly, in order to facilitate a closed-loop cooking process, gas cooktop 100 or griddle assembly 128 may include a temperature sensing assembly 150 for monitoring the temperature of griddle 130. For example, according to the illustrated embodiment, temperature sensing assembly 150 may generally include one or more temperature sensors (e.g., one sensor illustrated in FIG. 1) for monitoring the temperature of one or more cooking zones, respectively. Each temperature sensor may be embedded within their respective heating zones, e.g., approximately at a middle of each zone. It should be appreciated that temperature sensing assembly 150 may be permanently fixed in griddle 130 or may be removable.

According to example embodiments, each temperature sensing assembly 150 may include a sensor housing 160 and a temperature probe 162 extending therefrom for receipt within griddle 130. In general, sensor housing 160 may be configured for docking with a communication port (not shown) on griddle 130 or top panel 102 for providing electrical communication between the temperature probe 162 and controller 126. According to still other embodiments, temperature sensing assembly 150 may be wireless, and sensor housing 160 may contain operating electronics and a wireless communication module, e.g., for communicating with controller 126 of gas cooktop 100. For example, the sensor housing 160 and temperature probe 162 may be formed as a single, hermetically sealed package.

As used herein, “temperature sensor” or the equivalent is intended to refer to any suitable type of temperature measuring system or device positioned at any suitable location for measuring the desired temperature. Thus, for example, temperature sensing assembly 150 may include any suitable type of temperature sensor, such as a thermistor, a thermocouple, a resistance temperature detector, a semiconductor-based integrated circuit temperature sensor, etc. In addition, temperature sensing assembly 150 may be positioned at any suitable location and may output a signal, such as a voltage, to a controller that is proportional to and/or indicative of the temperature being measured. Although exemplary positioning of temperature sensors is described herein, it should be appreciated that gas cooktop may include any other suitable number, type, and position of temperature sensors according to alternative embodiments.

According to example embodiments, gas cooktop 100 may further include a griddle detection system 170 that is generally configured to determine whether griddle 130 is properly installed on top of grate 106. In this regard, controller 126 may be in operative communication with the griddle detection system 170 such that the presence of griddle 130 may be detected or monitored. As described in more detail below, the operation of gas cooktop 100 may vary depending on whether griddle 130 is present. It should be appreciated the griddle detection system 170 may be any suitable switch, trigger, sensor, or other device that is intended to detect the proper positioning of griddle 130 on gas cooktop 100. According to still other embodiments, griddle detection system 170 may be integrated into sensor housing 160, e.g., such that proper electrical connection between temperature probe 162 and controller 126 may act as a griddle detection system 170.

Referring now briefly to FIG. 2, gas cooktop 100 may further include one or more control knob assemblies 180 that are configured for regulating the heat output from each heating element 104, as described above. In this regard, control knob assemblies 180 may be the same or similar to control knobs 122 described above. Notably, control knob assemblies 180 may be generally configured for manually regulating the heat output of a respective heating element 104. This mode of operation may be referred to herein as the “manual” or “normal” mode of operation. By contrast, control knob assemblies 180 may be used herein to place the gas cooktop 100 in a “griddle mode” of operation, which will be described in more detail below.

According to the illustrated embodiment, each control knob assembly 180 may generally include a manual valve 182 for manually regulating a heating level of a respective heating element 104. As illustrated, manual valve 182 may also be turned into a position where the “auto griddle mode” is activated. When auto griddle mode is activated, and griddle detection system 170 confirms the presence of griddle 130, temperature control for the particular zone of the griddle may be regulated by manipulating encoder 184. In this regard, encoder 184 may be rotated to set a particular cooking temperature, e.g., in degrees Fahrenheit, or any other suitable manner of setting the heating level (e.g., on a scale of 1 to 10, high-medium-low, etc.). For example, in FIG. 2, the first control knob on the left provides no heat because manual valve 182 is in the off position. The second control knob from the left has the manual valve turned to the simmer position, such that a simmering operation is performed. The third control knob from the left has the manual valve 182 turned to the auto griddle position and the temperature set at 250° F., such that closed-loop cooking on that respective heating zone is performed at 250° F. The last control knob has the manual valve 182 turned to the auto griddle position and the temperature set at 460° F., such that closed-loop cooking on that respective heating zone is performed at 460° F.

Now that the construction and configuration of cooktop appliance 100 has been described according to exemplary embodiments of the present subject matter, an exemplary method 200 for operating cooktop appliance 100 will be described according to an exemplary embodiment of the present subject matter. Method 200 can be used to operate cooktop appliance 100, or may be used to operate any other suitable cooktop appliances. In this regard, for example, controller 126 may be configured for implementing some or all steps of method 200. Further, it should be appreciated that the exemplary method 200 is discussed herein only to describe exemplary aspects of the present subject matter and is not intended to be limiting.

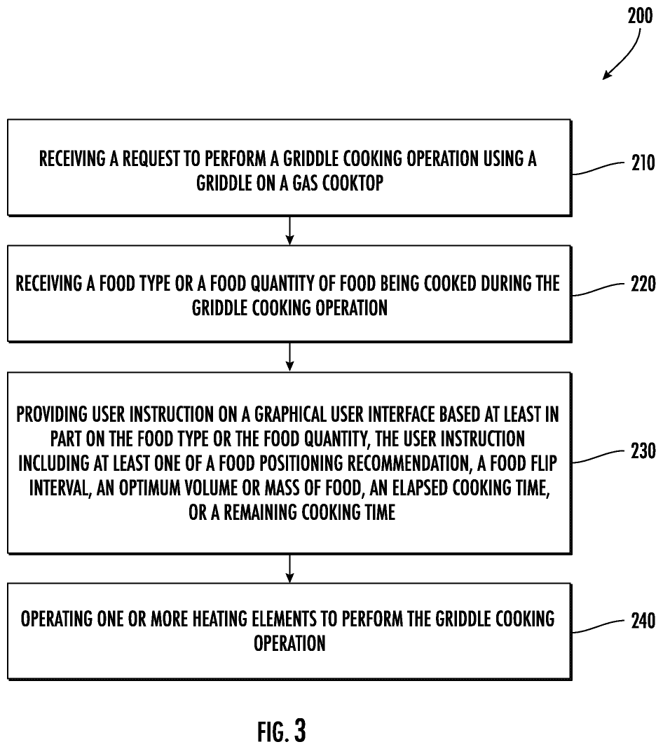

Referring now to FIG. 3, method 200 includes, at step 210, receiving a request to perform a griddle cooking operation on a cooktop. For example, continuing the example from above, the user may manipulate control knob assemblies 180 to request a griddle cooking operation using griddle 130 of gas cooktop 100. According to example embodiments, a user may also manipulate interactive display 124 to facilitate appliance operation, input cooking parameters, receive prompts or provide notifications from gas cooktop 100, etc.

As explained above, it may be desirable to ensure that griddle 130 is present before initiating a closed-loop cooking mode. Accordingly, method 200 may generally include determining that a griddle is present on a cooktop using a griddle detection system. In this regard, griddle detection system 170 may be used to determine that griddle 130 is properly positioned in place and that temperature sensing assembly 150 is properly communicating temperatures to controller 126, e.g., to facilitate the closed-loop cooking process. According to example embodiments, method 200 may further include determining that the griddle is not present on the cooktop using the griddle detection system and providing a user notification that the griddle is not present. In this regard, controller 124 may prevent initiation of the griddle mode of operation until a user has properly installed the griddle.

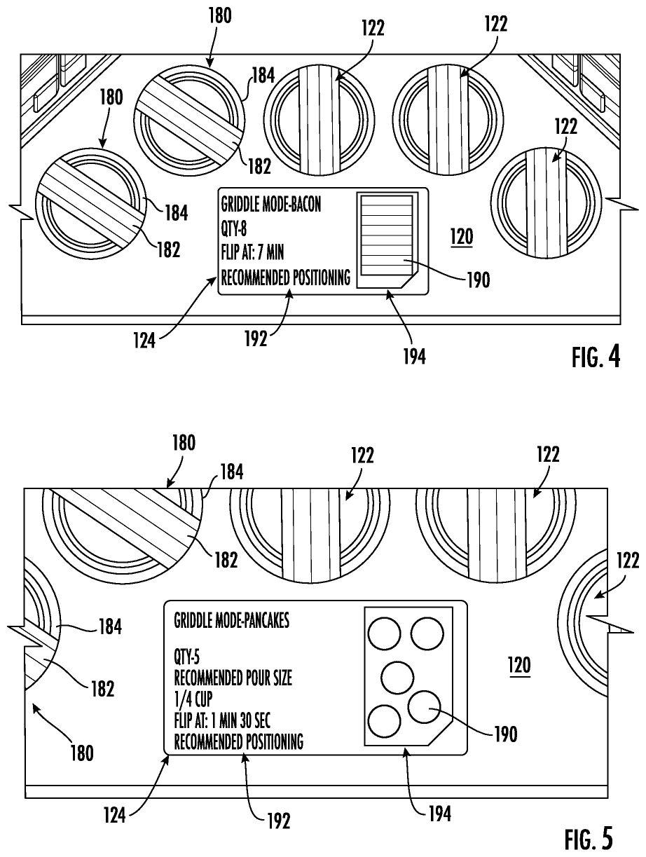

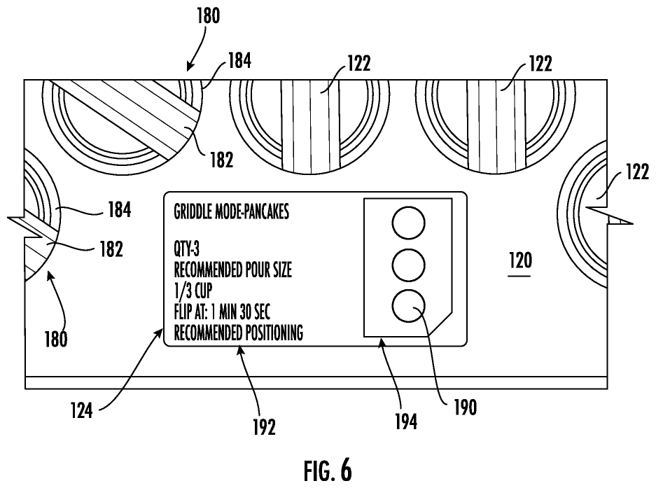

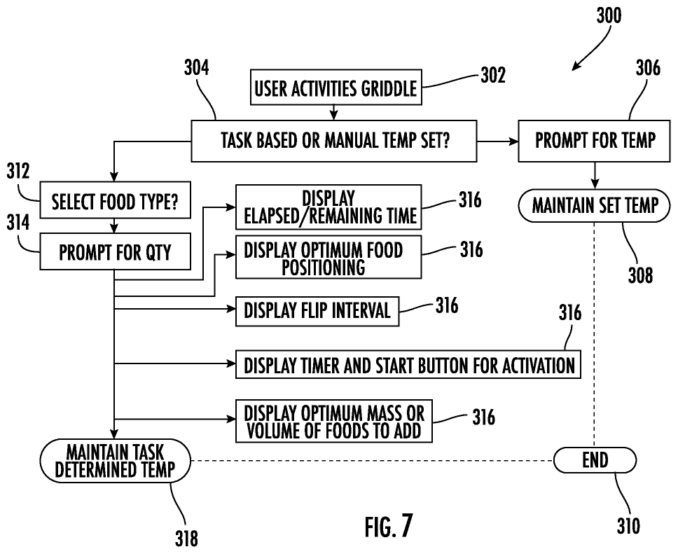

As explained herein, aspects of the present subject matter are generally directed to providing user guidance regarding the performance of the griddle cooking operation using griddle 130 on gas cooktop 100. Notably, this user guidance or instruction may be customized or adjusted depending on the particular food type, food quantity, food positioning, desired doneness, etc. of food being cooked on griddle 130. For example, this food is identified schematically by reference numeral 190 in FIGS. 4 through 6, and may include bacon, pancakes, meats, vegetables, or any other suitable edible items.

Step 220 may generally include receiving a food type and/or a food quantity of food 190 being cooked during the griddle cooking operation. In this regard, a user may select a food type and food quantity using interactive display 124. In this regard, when a user initiates a closed-loop griddle cooking process, interactive display 124 may prompt the user to input the food type, the food quantity, or other useful cooking information. According to example embodiments, interactive display 124 may include a touchscreen to facilitate such user inputs. According to still other embodiments, the user may interact with gas cooktop 100 through control knobs 122 or a remote device, e.g., such as a user's cell phone.

Step 230 generally includes providing user instructions on a graphical user interface based at least in part on the food type or the food quantity. In this regard, interactive display 124 may provide user instructions that include cooking guidance or recipe directions (e.g., identified generally by reference numeral 192 in FIGS. 4 through 6) or a visual aid or graphical display/representation of the griddle 130 and positioning of food items 190 (e.g., identified generally by reference numeral 194 in FIGS. 4 through 6). Although exemplary recipe directions 192 and graphical displays 194 are illustrated herein, it should be appreciated that these are only examples intended to facilitate discussion of aspects of the present subject matter and not limit the scope of the present subject matter in any way.

Referring now specifically to FIGS. 4 through 6, the cooking guidance 192 may generally include any advice or recommendations provided to a user to facilitate an improved cooking process of food items 190. For example, the cooking guidance 192 may include the name of the food items 190 being cooked and the quantity of food items 190 being cooked. In addition, cooking guidance 192 may include an elapsed cooking time, a remaining cooking time, or a time when food items 190 should be rotated or flipped. In addition, according to example embodiments, cooking guidance 192 may include recommendations for adjusting a cooking temperature at a certain time during the cooking process or any other suitable cooking adjustments.

In addition, according to example embodiments, cooking guidance 192 may generally include a recommendation regarding an optimum volume or mass of food. In this regard, for example, if a user is cooking pancakes, method 200 may include providing a user recommendation as to the pour volume for improving the quality of the cooked pancakes. By contrast, if a user is cooking meats or other items where the thickness or size may affect the cooking process, cooking guidance 192 may include recommendations on the size of those food items 190.

As illustrated, graphical display 194 may provide a visual representation of griddle 130 along with the recommended positioning of food items 190. In this regard, an image of the food items 190 overlaid on an image of the griddle may provide positioning guidance that is determined based on the food type, the food quantity, or other cooking information. Accordingly, cooking guidance 192 and graphical display 194 may provide a user with all the necessary information to facilitate an improved cooking process for the specific food items 190 being cooked.

Referring again to FIG. 3, step 240 may generally include operating a plurality of heating elements to perform the griddle cooking operation. According to example embodiments, this griddle cooking operation may be a closed-loop cooking process, e.g., relying on a closed loop feedback control algorithm with a cooking temperature and a target cooking temperature as inputs. Accordingly, step 240 may include obtaining one or more temperatures in one or more zones of griddle 130. For example, temperature sensing assembly 150 may continuously or periodically monitor the temperature of griddle 130. It should be appreciated that the frequency of temperature sampling may vary while remaining within the scope of the present subject matter. Based on the target cooking temperature of the griddle cooking operation, step 240 may include operating the plurality of heating elements to drive the cooking temperature to the target cooking temperature.

In this regard, step 250 may include implementing a closed loop feedback control algorithm based on the measured griddle temperature relative to the target temperature. According to example embodiments, the closed loop feedback control algorithm may include the use of proportional (P), proportional-integral (PI), or proportional-integral-derivative (PID) control for feedback-based control implemented with, e.g., temperature feedback from one or more temperature sensing assemblies 150. It should be appreciated that other suitable methods of performing closed-loop control are possible and within the scope of the present subject matter.

Although method 200 is described above as heating griddle 130 to a common target temperature (e.g., across the entire surface of the griddle), it should be appreciated that aspects of the present subject matter may be equally applicable to the use of a multi-zone cooking process that may facilitate cooking multiple different food items simultaneously. In this regard, the griddle cooking operation may include independent operation of heating elements associated with different heating zones, may include collective operation of multiple heating elements to maintain a single, common, or uniform griddle temperature, and/or may include simultaneous operation of heating elements in both an open-loop and closed-loop manner.

Referring now specifically to FIG. 7, an exemplary flow diagram or decision tree of a method 300 of operating gas cooktop 100 will be described. It should be appreciated that method 300 may include many of the same or similar steps as method 200. Accordingly, aspects of methods 200 and 300 are generally considered to be interchangeable to form still other methods of operation, and such methods are within the scope of the present subject matter.

As shown, method 300 may include, at step 302 determining that a user has activated the griddle. For example, step 302 may include detecting the presence of griddle 300 using griddle detection assembly 170 and determining that manual valves 182 have been placed in the auto griddle position. Step 304 may include determining whether the cooking process is task-based or if the user desires to set a manual temperature only. Step 306 may include prompting a user for the target cooking temperature if a manual temperature cycle is selected. Step 308 may then include operating the plurality of heating elements 104 in a closed loop manner to maintain the cooking temperature (e.g., as measured by temperature sensing assembly 150) at the target cooking temperature. Step 310 may include ending method 300 when the cooking process is complete.

If step 304 results in a determination that a task-based cooking operation has been selected, a user may be prompted for the type of food at step 312 and the quantity of food at step 314. As explained above, controller 126 may be programmed for providing user instructions based on the food type and food quantity. Accordingly, step 316 may generally include providing various user guidance, such as displaying elapsed or remaining cooking time, displaying optimum food positioning, displaying a food flip interval, displaying a timer and the start button for activation, and/or displaying an optimum mass or volume of foods to add. Once the user has implemented the recommendations and presses the start button, step 318 may include performing a closed-loop griddle cooking operation. Notably, the user instructions 316 may automatically update or advance as the cooking process proceeds. Step 310 includes ending method 300 after the cooking process has been completed.

FIGS. 3 and 7 depict exemplary control methods having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of methods 200 and 300 are explained using cooktop appliance 100 as an example, it should be appreciated that these methods may be applied to the operation of any suitable cooktop appliance capable of receiving a griddle.

As explained herein, aspects of the present subject matter are generally directed to a household cooking appliance having a cooktop, a digital display such as a liquid crystal display (“LCD”), a thermostatically controlled griddle, and an automatic griddle mode of operation where the display prompts for a food type/task. In this regard, the display may prompt for food type selection after a griddle mode has been activated, automatically controlling the griddle heat in accordance with the task. The display may further provide visual instructions for optimum positioning of foods for best results, which could be helpful for optimized performance and enhanced user experience. Depending on the task selected, additional information such as the proposed time to flip, preset timer features, volume of liquid to add, elapsed time, and other cooking recommendations may be presented to the user through the display.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a cooktop, the cooktop comprising one or more heating elements, a griddle removably positioned over the one or more heating elements, and a graphical user interface, the method comprising:
receiving a request to perform a griddle cooking operation;
receiving a food type of food being cooked during the griddle cooking operation;
providing user instruction on the graphical user interface based at least in part on the food type, the user instruction comprising a food positioning recommendation; and
operating the one or more heating elements to perform the griddle cooking operation.

2. The method of claim 1, further comprising:
receiving a food quantity of the food being cooked during the griddle cooking operation; and
providing the user instruction based at least in part on the food quantity.

3. The method of claim 1, wherein the user instruction further comprises a food flip interval.

4. The method of claim 1, wherein the user instruction further comprises an optimum volume or mass of food.

5. The method of claim 1, wherein the user instruction further comprises an elapsed cooking time or a remaining cooking time.

6. The method of claim 1, wherein providing the user instruction comprises:
operating the graphical user interface to display an image of the food overlayed on the griddle.

7. The method of claim 1, wherein the cooktop further comprises a temperature sensing assembly for monitoring a cooking temperature of the griddle, wherein operating the one or more heating elements perform the griddle cooking operation comprises:
determining a target cooking temperature based on the food type or a food quantity;
obtaining the cooking temperature using the temperature sensing assembly; and
operating the one or more heating elements to drive the cooking temperature to the target cooking temperature.

8. The method of claim 7, wherein operating the one or more heating elements to drive the cooking temperature to the target cooking temperature comprises:
implementing a closed loop feedback control algorithm based on the cooking temperature and the target cooking temperature.

9. The method of claim 8, wherein the closed loop feedback control algorithm comprises a proportional control algorithm, a proportional-integral control algorithm, or a proportional-integral-derivative control algorithm.

10. The method of claim 1, wherein the cooktop further comprises a griddle detection system, the method further comprising:
determining that the griddle is present on the cooktop using the griddle detection system before implementing the griddle cooking operation.

11. The method of claim 1, wherein the cooktop further comprises a temperature sensing assembly for monitoring a cooking temperature of the griddle, wherein operating the one or more heating elements perform the griddle cooking operation comprises:
determining that the griddle cooking operation includes a manual cooking temperature;
obtaining the cooking temperature using the temperature sensing assembly; and
operating the one or more heating elements to drive the cooking temperature to the manual cooking temperature.

12. The method of claim 1, wherein the griddle defines a first heating zone and a second heating zone, a temperature sensing assembly monitors a first zone temperature of the first heating zone and a second zone temperature of the second heating zone, the method further comprising:
receiving a command that the griddle cooking operation includes a first target temperature and a second target temperature;
obtaining the first zone temperature and the second zone temperature using the temperature sensing assembly; and
operating the one or more heating elements to drive the first zone temperature to the first target temperature and the second zone temperature to the second target temperature.

13. The method of claim 1, wherein the cooktop further comprises a control knob assembly comprising a manual valve for manually regulating a heating level of a heating element of the one or more heating elements or placing the heating element in a griddle mode; and
an encoder for regulating a target cooking temperature of a heating zone associated with the heating element in the griddle mode.

14. A cooktop defining a vertical direction, a lateral direction, and a transverse direction, the cooktop comprising:
one or more heating elements;
a griddle removably positioned over the one or more heating elements;
a temperature sensing assembly operably coupled to the griddle for monitoring a cooking temperature of the griddle;
a graphical user interface; and
a controller in operative communication with the one or more heating elements, the temperature sensing assembly, and the graphical user interface, the controller being configured to:
receive a request to perform a griddle cooking operation;
receive a food type of food being cooked during the griddle cooking operation;
provide user instruction on the graphical user interface based at least in part on the food type, the user instruction comprising a food positioning recommendation; and
operate the one or more heating elements to perform the griddle cooking operation.

15. The cooktop of claim 14, wherein the controller is further configured to:
receive a food quantity of the food being cooked during the griddle cooking operation; and
provide the user instruction based at least in part on the food quantity.

16. The cooktop of claim 14, wherein the user instruction further comprises a food flip interval.

17. The cooktop of claim 14, wherein the user instruction further comprises an optimum volume or mass of food.

18. The cooktop of claim 14, wherein providing the user instruction comprises:
operating the graphical user interface to display an image of the food overlayed on the griddle.

19. The cooktop of claim 14, wherein the cooktop further comprises a temperature sensing assembly for monitoring a cooking temperature of the griddle, wherein operating the one or more heating elements perform the griddle cooking operation comprises:
determining a target cooking temperature based on the food type or a food quantity;
obtaining the cooking temperature using the temperature sensing assembly; and
operating the one or more heating elements to drive the cooking temperature to the target cooking temperature.

20. The cooktop of claim 14, wherein the cooktop further comprises a griddle detection system, the controller being further configured to:
determine that the griddle is present on the cooktop using the griddle detection system before implementing the griddle cooking operation.
